(19) United States
(12) Patent Application Publication
(10) Pub. No.: US 2011/0020006 A1
(43) Pub. Date: Jan. 27, 2011

(54) SELF CONFIGURABLE OPTICAL LINK

(75) Inventor: Steen Bak Christensen, Roskilde (DK)

Correspondence Address: BUCHANAN, INGERSOLL & ROONEY PC, POST OFFICE BOX 1404, ALEXANDRIA, VA, 22313-1404, US

(73) Assignee: IPtronics A/S, Roskilde (DK)

(21) Appl. No.: 12/843,900

(22) Filed: Jul. 27, 2010

Related U.S. Application Data
(60) Provisional application No. 61/228,848, filed on Jul. 27, 2009.

(51) Int. Cl. H04B 10/12; H04B 10/00

(52) U.S. Cl. 398/116; 398/140; 398/141

(57) ABSTRACT

An optical link for communicating a payload data stream between a near end transceiver and a far end transceiver via an optical communication channel, the near end transceiver including a near end receiver (near-Rx) and a near end transmitter (near-Tx) and the far end transceiver including a far end receiver (far-Rx) and a far end transmitter (far-Tx), wherein the far-TX is adapted to transmit a link data stream to the near-RX beside the payload data stream from the far end to the near end.

### TECHNICAL FIELD

An optical link for communicating a payload data stream between a near end transceiver and a far end transceiver via an optical communication channel.

### BACKGROUND ART

The demands for ever-increasing bandwidths in digital data communication equipment at reduced power consumption levels are constantly growing. These demands not only require more efficient integrated-circuit components, but also higher performances, interconnect structures and devices. Indeed, as one example, the International Technology Roadmap for Semiconductors (ITRS) projects that high performance chips in the very near future will have operating frequencies, both on-chip and off-chip, rising above 50 GHz. Conventional metal-wire based interconnects have played a central role in the microelectronics revolution. It is apparent that wire-based interconnect devices will be challenged to enabling even higher operating frequencies.

However, besides challenges with regard to bandwidth, the wire-based interconnect of the future may struggle significantly with a high power consumption. The power requirement of electronic components typically increases with increased bandwidth, which in some cases results in increased cooling requirements which further increases the power consumption of the electronic system as a whole. The power and cooling requirement may be particularly challenging to meet in data centers where larger quantities of servers are pooled often closely spaced. Such pooling inherently requires large quantities of interconnects which therefore may add significantly to the power and cooling requirements of the datacenter.

One approach to solve this problem includes utilizing optical interconnects as an alternative to wire-based interconnections, as optical fibers have a significantly higher bandwidth relative to an electrical wire. It is therefore an object of the present invention to provide means for reducing the power requirement of an optical interconnect.

An optical interconnect is typically composed by a transceiver module in each end adapted to transmit optical information along one or two optical fibers. The transceiver may be formed by a single chip or two or more chips. The transmitter of each transceiver typically comprises a driver circuit arranged to drive a light emitter coupled to the fiber typically with a binary signal, and a receiver circuit coupled to a photo diode coupled to the fiber arranged to receive the signal. In such a setup the light emitter typically consumes a significant part of the power requirement of the optical interconnect.

In a typical optical interconnect Vertical Cavity Surface Emitting Laser (VCSEL) diodes are utilized as light emitter to transmit binary data over optical fibers. However, the light source may in principle be any suitable light source and the transmitted waveform may be any suitable waveform for transmitting information. Most light emitters have a threshold current above which they substantially begin to emit light. Increasing the current driven through the emitter from zero to above said threshold may be time consuming, and therefore a bias current is typically driven through the light source. Often the bias current is set just below, at the threshold or above the threshold but it may also be set to be well above threshold. This bias current is often programmable so as the same circuit design may be utilized to drive different light emitters and/or used for different applications. Additional time varying current which modulates the emission from the light emitter is referred to as the modulation current.

For a VCSEL the suitable modulation and bias current values change with temperature so the driver is programmed with VCSEL characteristics that describe the performance as a function of temperature. The actual operation of the driver is then determined by the temperature and the programmed values.

To ensure stable operation it is often necessary to characterize each VCSEL individually, or if the uniformity from VCSEL to VCSEL is sufficiently good it is necessary to characterize the VCSEL on a batch level to determine suitable bias and modulation currents. One of the main problems with the manufacturing of VCSEL is that the uniformity from batch to batch may be poor and therefore it may not be possible to use the same programming for all VCSEL's.

In addition, the bias and modulation currents change with the age of the VCSEL, but most systems do not have a method for compensating for aging of the VCSEL. Some systems overcome this by a build in timer adding further complexity to the system. Again aging may not be well characterized for VCSEL's and may have large batch to batch variation. This also means that it may not be possible to have a reliable end of life warning at least not without a large safety margin.

### DISCLOSURE OF INVENTION

An object of the present invention is to overcome one or more of the drawbacks of the prior art described above.

In one embodiment the invention relates to an optical link for communicating a payload data stream between a near end transceiver and a far end transceiver via an optical communication channel, said near end transceiver comprising a near end receiver (near-Rx) and a near end transmitter (near-Tx) and said far end transceiver comprising a far end receiver (far-Rx) and a far end transmitter (far-Tx), wherein said far-TX is adapted to transmit a link data stream to the near-RX beside the payload data stream from the far end to the near end. In one embodiment the link is arranged so that the link data may be relayed from said near-RX to the near-TX so that adjustment may be made to the near TX according to the link data. In one embodiment this means that the far-RX, which is connected to the near-TX, functions as a monitor of the link quality and provides feedback, via the optical link, to the near-TX. In one embodiment the near-RX performs the same function in relation to the far-TX. Any system variations due to temperature and/or aging may be removed automatically. As a consequence the transmitter, in particular the light emitter such as a VCSEL, may not have to be characterized and adjusted in the manufacturing process. In one embodiment a simple link test is performed to ensure that the link is operating correctly. By way of the invention the optical link may be allowed to configure the bias, modulation currents as well as other performance parameters such as e.g. equalization, (e.g. pre-emphasis), and receiver settings.

Accordingly, in one embodiment the invention relates to a method of transmitting and receiving data via an optical link according to the invention comprising
a. at the far-end transceiver measuring one or more first parameters relating to the quality of the link from the near end to the far end
b. transmitting a link data stream, related to said one or more first parameters, to the near end receiver beside a payload data stream
c. adjusting the near-TX based on the link data stream.

As the transceivers are optical transceivers the transmitter of either end will inherently comprises a light emitter, throughout this text exemplified by a VCSEL, and a corresponding driver circuit. Therefore, in one embodiment adjusting the near-TX comprises adjusting driving conditions for said light emitter, such as bias and/or modulation currents. The link inherently comprises a near-end input from which the link may receive payload data stream from a system in which the link operates. Similarly the link comprises a far-end output where the payload data stream may be delivered by the link.

For convenience the two ends of the optical link has been referred to as near and far ends where the far-TX transmits link data to the near-RX. However, in one embodiment the ends are reversed so that the near end performs the functions of the far end described above and all other features are adapted accordingly. In one embodiment both ends transmit and receive link data from the other end so that both the far-TX and the near-TX may be adjusted according to the invention. Link data sent in the link data stream may in principle be any data suitable for indicating performance or quality of the link. As will be realized by the skilled person several figures of merit are possible. When the far-RX receives payload data it may measure one or more parameters related to the quality of the received data. These parameters may include one or more of the average optical power (AOP), the optical modulation amplitude (OMA), and extinction ratio (ER) as well as a power in the signal in one or more frequency intervals. The latter may in one embodiment be applied to determine the shape of the signal or some indicator of the shape of the signal. In one embodiment the shape of the signal may be applied to determine whether sufficient bias is supplied to the VCSEL as insufficient bias current may affect the shape of e.g. binary 1's. Similarly in one embodiment the link may be designed to find and operate the VCSEL with minimum bias. In one embodiment the near-TX may reduce bias current until the shape of the signal is affected to determine a lower threshold. In one embodiment a lower threshold is determined at least partly by determining the extinction ratio. In one embodiment the link may be designed to operate the VCSEL with a bias current above threshold. In one embodiment with a minimum bias current satisfying this requirement the ER may be determined as the bias current is decreased. When the ER rises significantly the bias current may be below threshold. In one embodiment measurement of the shape of the signal is applied to determine a setting of pre-emphasis of e.g. on the front or back of a pulse corresponding to a binary 1. As will be clear to the skilled person, the link data may comprise the measured parameters themselves and/or calculated derivates thereof. For example, the ER may be a calculated measure at least partly based in the OMA and the AOP. Depending on the design the calculation of the ER may be located at the far-end transceiver (e.g. in far-RX), the near-end transceiver, or in a controller device. The same consideration may be valid for other calculated parameters. However, whether the measured parameters themselves, are transmitted via the link data stream or data processing is performed prior to this transmission may affect the required bandwidth of the link data stream. In one embodiment one or more of said far-RX, far-TX, near-RX, near-TX and a controller circuit perform computation on the measured parameters. In one embodiment such processing is performed in the far-end to reduce the amount of link data to be transmitted. In one embodiment processing comprises filtering and/or averaging either weighted or un-weighted. The link data may also comprise adjustment commands for the near-TX, such as increase/decrease bias etc. In one embodiment such adjustment commands will be derived from measured parameters e.g. in one embodiment derived from an initialization or adjustment algorithm arranged to adjust the parameters for the near-TX.

In one embodiment the link comprises one or more controllers adapted to control the adjustment such as setting the current source in the driver circuit of the transmitter based on the link data stream. The controller may be external to the transceiver, internal to the transceiver, form part of the receiver, the transmitter or a combination thereof.

The quality of data is in this context taken to relate to characteristics of the transmitted payload data relating to the comprehensibility of the payload data rather than the contents of the payload data.

In use the optical link is used to transport, generally referred to as transmit, payload data between two parts of a system. This could be internally in a computer device, for example relaying data from a CPU to a harddrive, between two servers, between memory and processor, to and from a graphics adapter in a computer, or in a link between components in a network. In order to provide easy integration it may in one embodiment be advantageous that the link does not impose protocol requirements upon the payload data. In that way that optical link and the system may in one embodiment be designed separately with fewer or no consideration of functionality of the other. However, in one embodiment such considerations do comprise rudimentary requirements such as maximum bandwidth of the link and current supply to the links etc.

In one embodiment the optical link is an optical active cable where the transceivers and the optical communication channels (commonly one or more optical fibers) are integrated in such as way that the cable interfaces with the system in a manner similar to that of an electrical cable. From a system perspective the only differences is in one embodiment that the active cable requires a supply of electrical power and that it has a larger bandwidth than the electrical cable.

In one embodiment the optical link is a short reach optical link having a length of the optical communication channel of less than 5 km, such as less than 1 km, such as less than 100 m, such as less than 50 m, such as less than 20 m, such as less than 10 m, such as less than 1 m, such as less than 50 cm, such as less than 25 cm, such as less than 5 cm.

In the context of the present invention the phrase “beside the payload data stream” is in one embodiment taken to mean that the link data stream may be transmitted while payload data is transmitted as opposed to between packets of payload data. In one such embodiment the link advantageously does not impose requirements on the temporal structure of the payload data stream provided to the input of the link. Such a requirement imposed on the temporal structure could for example be that the payload data stream is in the form of a burst mode data stream where a header may be transmitted before each pulse of data. In one embodiment the “beside the payload data” means that the temporal structure of the payload data stream is not altered in the link. In one embodiment “beside the payload data” the link data stream is modulated on top of the payload data stream rather than encoded into the data stream. In one such embodiment transmitting beside the payload data also allows the link to be implemented without circuitry for re-clocking the transmitted data streams (such as via a CDR) such as to remove an encoding of the link data stream into the payload data stream. Such re-clocking could for example otherwise be applied e.g. to receive a payload from the system in which the optical link is used, recode the payload data to allow for transmission of the link data stream, and remove this recoding at the other end. Accordingly, in one embodiment the invention provides the benefits discussed above without requiring adaptation by the system, in which the link is to function and/or without requiring substantial complexity in the transceivers such as by requiring re-clocking and/or buffering of payload data. In one embodiment the link may require the payload data stream to be encoded for example by 8B/10B encoding, to ensure a certain minimum bandwidth and/or a DC balance in the signal. Such encodings may in one embodiment be inherent to the system, in which the link is inserted, such as network system based on the Ethernet protocol. In one embodiment in which the payload data stream is such encoded the encoded payload data stream provided to the input of the link is in the context of the present text considered the payload data stream in relation to the link. In one such embodiment the link is arranged so that an encoded payload data stream is input to the link and the same encoding is found in the transmitted payload data stream on the output of the link.

In one embodiment the link data stream is transmitted beside the payload data stream along said optical communication channel. In one embodiment said link data stream is multiplexed with said payload data steam. In one embodiment the link data stream is modulated on the payload data stream. In one embodiment said multiplexing comprising one or more of DC level modulation, modulation of the modulation current and phase modulation. In one embodiment the near end receiver comprises a circuit for determining threshold of the signal in case of binary signal. This value is in one embodiment related to the DC level of the signal. In one embodiment the near end receiver comprises a circuit for determining the peak value of the signal, for example in order to set the threshold for a binary signal. In one embodiment this peak value is related to the modulation current. In one embodiment a link data stream may be received by monitoring one or more of such determined variables in the near end receiver within a frequency band. In one embodiment two or more of such variables are modulated with the link data stream to improve robustness of the detection of the link data stream. In one embodiment two or more of such variables are modulated in phase. In one embodiment two or more of such variables are modulated out of phase, such as 90 degrees or 180 degrees out of phase.

Compared to the bandwidth of the payload data stream B_{data}, e.g. 10 GBit, the bandwidth of the link data stream Bₗᵢₙₖ is in one embodiment considerably less, which in one embodiment allows the link data stream to be multiplexed with the payload data e.g. by modulation of the modulation current. In one embodiment B_{data}/Bₗᵢₙₖ≧10, such as B_{data}/Bₗᵢₙₖ≧10², such as B_{data}/Bₗᵢₙₖ≧10³, such as B_{data}/Bₗᵢₙₖ≧10⁴, such as B_{data}/Bₗᵢₙₖ≧10⁵, such as B_{data}/Bₗᵢₙₖ≧10⁶. The link data stream may utilize an error correcting coding to ensure that the link data is correctly transmitted.

In one embodiment the link data stream is transmitted along a parallel communication channel, such as an electrical wire. For an optical link this embodiment typically requires additional wiring. In some applications such complication may be tolerable whereas other applications will prohibit such an implementation. An additional channel such as an electrical wire may also require additional circuitry in the transceiver. However, in one embodiment a parallel communication may provide a better sensitivity in the transmission of the payload data stream because this has little or no interference from the link data stream. In one embodiment the parallel communication channel is an optical channel. In one embodiment such a channel is applied to test the link quality of two or more channels in the array sequentially.

In one embodiment the optical link is part of an array of optical links, such as e.g. 4, 8 or 12 channels. In one embodiment such an array comprises a channel dedicated to transmission of link data. In one embodiment such a channel or another channel is applied to transmission of a redundant payload data stream. In that way the quality of the transmission of the payload data of one of the other channels in the array may be investigated. In one embodiment such a channel is applied to test the link quality and subsequently adjust the drive parameters of one of the other channels.

In one embodiment a redundant payload data stream may be utilized to compare the opening in an eye diagram or other eye diagram parameters. The channel transmitting redundant payload data may in one embodiment use settings with relatively high power consumption but where good link quality is more likely. This link may then be applied for reference. As several channels may in one embodiment be optimized via a single channel transmitting redundant data the array may be run more effectively in total. In one embodiment the channel sending redundant payload data is used infrequently, such as to increase the life time of this channel and/or to save power. In one embodiment the link further comprises means for testing the channel applied to sending redundant payload data so a reduced life time of this channel is less likely to disrupt the performance of the system. In one embodiment the channel applied to send redundant data may change between the channels of the array.

To ensure a good link performance and/or to minimize the power consumption the skilled person may implement a large variety of control schemes. In one embodiment such a control schemes comprises
a. Storing one or more critical link quality parameters accessible to the transceiver(s)

The critical link quality parameters provide a measure of the acceptable link quality. Such critical parameters may in principle be any parameter which may be determined from the received payload data stream. Examples comprise the OMA, ER, AOP, features of the eye diagram and bit error rates. Features of the eye diagram and/or bit error rates may be determinable via a redundant channel or via protocol implementation, such as via a checksum or a similar measure. Such an encoding of the payload data stream may be provided to the link in the payload data stream, i.e. from the system in which the link is inserted. This may be the case where the system applies such an encoding for other purposes.

The control scheme may further comprise:
b. Storing safe throughput parameter accessible to the transceiver(s) and
c. at start-up of said link using said safe throughput parameter for one or more of the near-RX, near-TX, far-RX and far-TX,

The safe throughput parameters are drive parameters and perhaps receiver parameters such as parameter for which a safe transmission of payload data is guaranteed or at least very likely. These are in one embodiment used during start-up of the link, or at least one of the transceivers, so as to provide a starting-point for the link after which the transmitters, and perhaps receivers, may be adjusted based on the transmitted link data stream, which in turn is derived from the transmitted payload data stream. In one embodiment the link uses a known data set, such as a stored dataset or a dotting sequence, as the initial payload data in order to initialize the link. The safe throughput parameters may also be applied in the event of a data loss, so that the transmission of payload data may be restored. Depending on the design and implementation of the invention the safe throughput parameters may be provide throughput without exact knowledge of one or more parameters which would have been applied in the transmission of a prior art link. As discussed above in one embodiment the VCSEL will not have been subjected to calibration and therefore the safe throughput parameters may in such an embodiment comprise a bias current and modulation current which is likely to provide throughput regardless of, at least expected, production variations. In one embodiment the bias current of the safe throughput parameters is sufficiently high that the VCSEL is run above threshold to ensure that the 1's of the payload data stream are not distorted and/or that the due cycle is far from 50% due to a long turn on time for the VCSEL. In one embodiment the safe throughput parameters have different settings depending on the temperature of the transceivers. In one embodiment the safe throughput parameters are set independent of temperature. In one embodiment the operations of the transceivers of the link is independent of a measured temperature. In one embodiment the link is arranged to store operational parameters (dependent or independent of temperature) in order to utilize these parameters at another start-up and/or in a data loss event. In one embodiment the link may utilize two or more sets of safe throughput parameters, so that if e.g. the first set of safe throughput parameters is sufficient for providing a safe transmission of payload data the link may start-up operating closer to the desired operation. The second set of safe throughput parameters may in one embodiment provide higher likelihood of safe transmission but start the link up further from desired operation.

Once in operation the link may in one embodiment
d. measure one or more parameters relating to the link quality parameter at the far end transceiver and/or measure one or more parameters one or more link quality parameters and communicating data relating to said parameters via a link data stream beside the payload data stream to the near end transmitter,
e. optionally extract one or more link quality parameters from said one or more parameters link quality parameter
f. and comparing said link parameter(s) of items c and d to the stored one or more critical link quality parameters, and
g. adjust the near-TX and/or far-RX (if necessary) based on said comparison.

In one embodiment said adjustment may be to achieve operation near said critical link parameter. In one embodiment the critical link parameter is an interval. Commonly, increased link quality will come at the cost of increased power consumption. In one such embodiment, a link quality better than said one or more critical link quality parameters will prompt the near-TX and/or far-RX to reduce power consumption. The critical link parameters are in one embodiment related to the requirement for providing a sufficiently stable link. Whether an adjustment is required or not may in one embodiment be determined via a specified tolerance.

In one embodiment the link comprises a control scheme comprising an iterative procedure for achieving safe throughput. In one embodiment the link initializes after having been turned on by transmitting real or stored data along the optical communication channel while indicating to the system in which the link is operating that the link is not operational. First after at least safe throughput is achieved does the link indicate that it is operational. In one embodiment this initialization procedure involves the utilizing safe throughput parameters such as described above.

### BRIEF DESCRIPTION OF DRAWINGS

The invention will be explained more fully below in connection with a preferred embodiment and with reference to the drawings in which:

FIG. 1 shows a prior art driver chip suitable for driving an array of up to 12 VCSELs,

FIG. 2 shows an schematic presentation of an optical link according to an embodiment of the invention, and

FIG. 3 shows a state diagram for an optical link according to an embodiment of the invention.

The figures are schematic and are simplified for clarity.

### MODE(S) FOR CARRYING OUT THE INVENTION

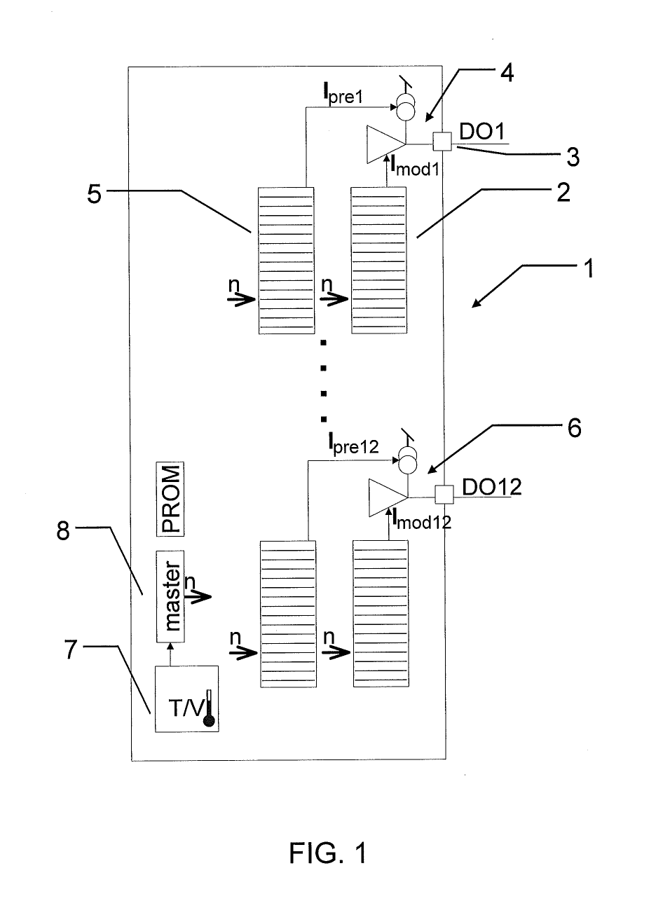

FIG. 1 shows a prior art driver chip 1 suitable for driving an array of up to 12 VCSELs connected to the output ports DO1 to DO12 (only D1 and D12 shown). For the VCSEL to be connected to DO1 3 connected to the driver circuit 4. The driver circuit 4 is arranged to obtain the amount of modulations current I_{mod1} and pre-emphasis Iₚᵣₑ₁ from the look-up tables 2 and 5, respectively. The driver circuit 6 is a duplicate of the driver circuit 4 arranged to drive a VCSEL connected to DO12. The index n is applied by each driver circuit to access the look-tables. The index is provided by a master circuit 8 and calculated from the temperature from a global thermometer 7. Accordingly, the schematically outlined parts of the chip 1 is arranged to drive VCSELs and adjust the modulation currents and pre-emphasis. As discussed above the values of the look-up tables are commonly determined by calibrating each VCSEL in the array. While a separate temperature calibration may be performed for each VCSEL a thermometer 7 acting as global thermometer for the chip may be used. Commonly, but not shown, a look-up table for the bias current may be included as well.

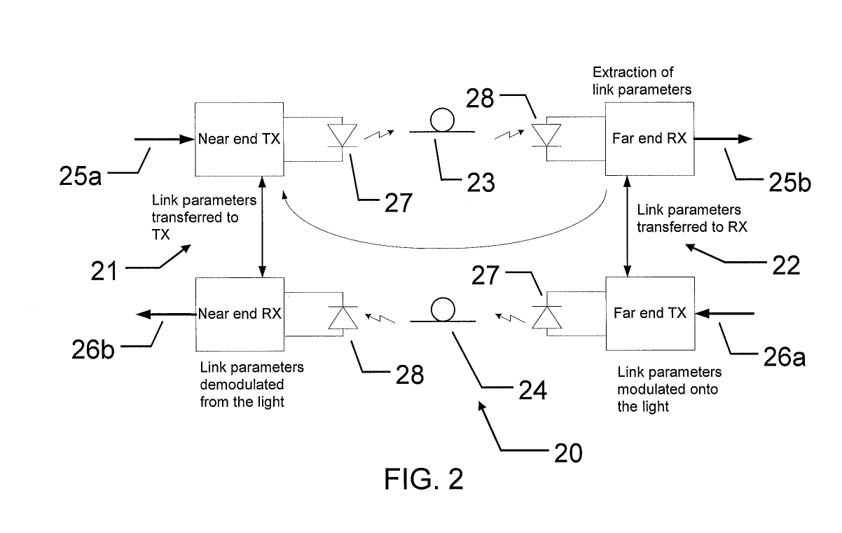

FIG. 2 shows a schematic outline of an optical link 20 according to an embodiment of the invention. The link 20 is configured with a near end transceiver 21 and a far end transceiver 22 with optical communication channels 23 24 schematically indicated as two optical fibers. At either end payload data is received by the link and relayed to the other end as indicated by the arrows 25a 25b 26a and 26b. The payload data is transmitted via the light emitters 27 and received via the photodiodes 28. In this example the Near end TX (i.e. near-TX) is adjusted based on the payload data send to the Far end RX (i.e. far-RX). First a payload data stream is received at far-RX. Here the link quality is assed resulting in a set of link parameters which are then relayed to the near-RX via the far-TX. The link parameters are finally relayed to the near-TX which may prompt an adjustment as previously discussed.

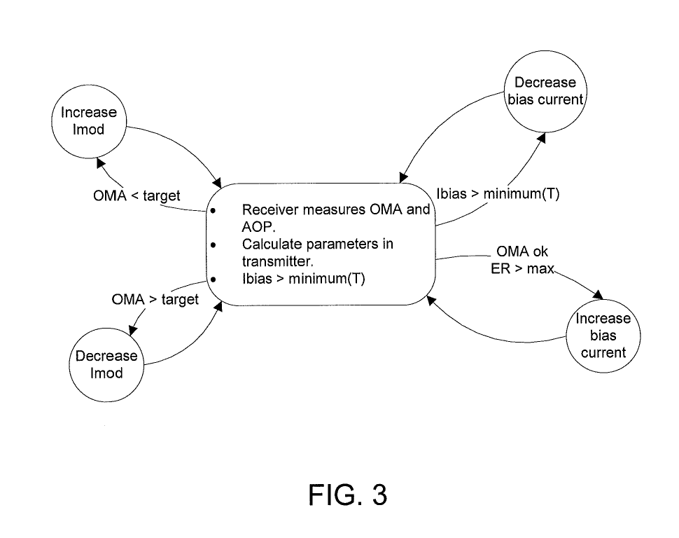

FIG. 3 shows an example of a state diagram for controlling the adjustment of the link according to one embodiment of the invention. In this example a minimum bias current as a function of temperature is determined for the light emitter. The receiver measure OMA and AOP and relays those values to the transmitter at the other end. The transmitter calculates the ER. The receiver is used to extract the incoming AOP and the OMA. From this it is possible to calculate the ER. For example: the AOP is in one embodiment proportional to the bias current in the receiver, which can easily be measured. OMA is measured from the received peak-peak amplitude. The critical link parameters are targets for the OMA and the ER, such as targets defined to ensure a stable link. Based on the measured and calculated parameters the transmitter is adjusted so that when
the OMA is below target the modulation current is increased
the OMA is above target the modulation current is decreased
the bias current is below the minimum value the bias is increased.
ER is above a maximum value the bias current is increased. In this way the VCSEL may be kept just above threshold so that signaling 0's correspond to emission of relative low optical power.

In one embodiment the link is subjected to the following tests prior to being put into operation:
1) Store minimum bias curve as a function of temperature on the driver
2) Store maximum ER on transmitter
3) Store minimum OMA on receiver, taking into account any stressed eye degradation.
4) Test full link at room temperature and ensure BER is ok.

In one embodiment an initialization process is utilized instead of having a stored minimum bias current as a function of temperature. Here a safe throughput value well above threshold is utilized after which the transmitter is allowed to decrease the bias current until the ER is above max after which bias current is increased again.

As mentioned above, the light emitter of a transmitter may in principle be any suitable light transmitter. Accordingly, when reference is made to VCSEL's this should be viewed as exemplary rather than limiting to this particular light emitter. It should also noted that any features provided as part of the examples may be combined with any other features provided in the description unless the features are mutually exclusive.

1. An optical link for communicating a payload data stream between a near end transceiver and a far end transceiver via an optical communication channel, said near end transceiver comprising a near end receiver (near-Rx) and a near end transmitter (near-Tx) and said far end transceiver comprising a far end receiver (far-Rx) and a far end transmitter (far-Tx), wherein said far-TX is adapted to transmit a link data stream to the near-RX beside the payload data stream from the far end to the near end.

2. The optical link of claim 1 wherein said link data stream is transmitted along said optical communication channel.

3. The optical link of claim 1 where said link data stream is multiplexed with said payload data steam.

4. The optical link of claim 1 wherein said link data are transmitted as a modulation of the payload data stream.

5. The optical link of claim 5 wherein said modulation is in the form of a least one of DC level modulation, modulation of the modulation current and phase modulation.

6. The optical link of claim 1 wherein said link data stream is transmitted along a parallel communication channel, such as an electrical wire.

7. The optical link of claim 1 wherein said far-RX is arranged to measure one or more parameters relating to the link quality and communicating data relating to said parameters to said far-TX.

8. The optical link of claim 7 wherein one or more of said far-RX, far-TX, near-RX, near-TX and a controller circuit perform computation on the one or more parameters.

9. The optical link of claim 7 wherein said one or more parameters comprises and/or is related to OMA and/or AOP of the payload data stream received by far-RX from the optical link.

10. The optical link of claim 1 wherein link data comprised in said link data stream comprises one or more of OMA, AOP, ER, Increase/decrease Bias, Increase decrease modulation or a related parameter.

11. The optical link of claim 1 wherein said payload data stream has a bandwidth B_{data} whereas the link data stream has a bandwidth Bₗᵢₙₖ stream wherein B_{data}/Bₗᵢₙₖ≧10, such as B_{data}/Bₗᵢₙₖ≧10², such as B_{data}/Bₗᵢₙₖ≧10³, such as B_{data}/Bₗᵢₙₖ≧10⁴, such as B_{data}/Bₗᵢₙₖ≧10⁵, such as B_{data}/Bₗᵢₙₖ≧10⁶.

12. The optical link of claim 1 wherein said near-TX and far-TX comprises a VCSEL diode and a corresponding driver.

13. The optical link of claim 1 wherein the near-TX is adapted to transmit a link data stream comprising link data to the far-RX beside the payload data stream from the far end to the near end.

14. The optical link of claim 1 wherein said optical link is an optical interconnect.

15. The optical link of claim 1 wherein said optical link is an optical active cable.

16. The optical link of claim 1 wherein said optical link is a short of reach optical link having a length of the optical communication channel of less than 1 km.

17. A method of transmitting and receiving data via an optical link according to claim 1 comprising
a. at the far-end transceiver measuring one or more first parameters relating to the link quality
b. transmitting a link data stream, related to said one or more first parameters, to the near end receiver beside a payload data stream
c. adjusting the near-TX based on the link data stream.

18. The method of claim 17 wherein the near-TX comprises a light emitter and said adjusting the near-TX comprises adjusting driving conditions for said light emitter, such as bias and/or modulation currents.

19. The method of claim 17 further comprising
a. Storing one or more critical link quality parameters accessible to the near end transceiver and far end transceiver, and
b. Storing safe throughput parameter accessible to the near end transceiver and far end transceiver, and
c. a start-up of said link using said safe throughput parameter for one or more of the near-RX, near-TX, far-RX and far-TX,
d. measure one or more parameters relating to the link quality parameter at the far end transceiver and/or measure one or more parameters one or more link quality parameters and communicating data relating to said parameters via a link data stream beside the payload data stream to the near end transmitter, and
e. optionally extract one or more link quality parameters from said one or more parameters link quality parameter, and
f. and comparing said link parameter(s) of items c and d to the stored one or more critical link quality parameters, and
g. adjusting the near-TX and/or far-RX based on said comparison.

20. The method of claim 17 where said adjustment is performed in order to bring one or more of said link quality parameters closer to said critical link parameters.
